(19) United States
(12) Patent Application Publication
(10) Pub. No.: US 2007/0068097 A1
(43) Pub. Date: Mar. 29, 2007

(54) Kiln door

(76) Inventors: Cameron Dean Mierau, Portland, OR (US); Lawrence Patrick Caleen, Portland, OR (US); Bruce Scott Bensen, West Linn, OR (US)

Correspondence Address: WATTS HOFFMANN CO., L.P.A., Suite 1750, 1100 Superior Avenue, Cleveland, OH, 44114-2518, US

(21) Appl. No.: 11/506,997

(22) Filed: Aug. 18, 2006

Related U.S. Application Data
(60) Provisional application No. 60/709,834, filed on Aug. 19, 2005.

(51) Int. Cl. E06B 1/04

(52) U.S. Cl. 52/204.1

(57) ABSTRACT

A door assembly for a kiln that includes a door frame formed by prefabricated vertical frame members that are interconnected with prefabricated lateral frame members. Insulated panel sections are replaceably supported by the door frame. Replaceable, peripheral door seals are held in track ways. The track ways are defined by the vertical and lateral frame members. Each lateral and vertical frame member includes a plurality of T-slots for receiving threaded members that are engagable with threaded fasteners used to hold the panel sections to the door frame. The door assembly includes clamp pressure receiving structure for receiving a clamping pressure exerted by a clamp mechanism forming part of the kiln structure whereby a sealing engagement is provided between a peripheral seal on the door frame. A roller extending outwardly from the door assembly is engagable by another, passing door assembly.

### CROSS-REFERENCE TO RELATED APPLICATION

This application claims priority from Provisional Application Ser. No. 60/709,834 filed on Aug. 19, 2005. Provisional Application No. 60/790,834 is incorporated in its entirety herein by reference.

### TECHNICAL FIELD

The present invention relates generally to processing lumber in a kiln and in particular, to a new and improved kiln door.

### BACKGROUND ART

Kilns are often used in the lumber industry to adjust the moisture content of lumber. Generally, a kiln is a rather large structure that defines one or more chambers in which the lumber is placed. When the lumber is being processed, it is important to seal the interior of the kiln from the outside atmosphere so that the environment within the drying chamber is controlled. It is also important that the heated air within the chamber be inhibited from leaking out of the chamber i.e., through door interfaces, etc.

Kilns typically have rather large access doors that are moved laterally to expose the door opening, through which the lumber is brought into the chamber. The doors are frequently the weakest and most troublesome part of the kiln structure. They can be easily damaged when they are opened or closed carelessly or by an inattentive operator who damages the door with lumber handling equipment. Because the doors are opened and closed by human operators in most cases, they are preferably constructed of lightweight materials which can be more easily damaged. It has been found that in many current kiln structures, the doors are susceptible to damage and are very difficult or costly to replace and/or repair.

### DISCLOSURE OF INVENTION

The present invention provides a new and improved kiln door that can easily replace existing kiln doors. The disclosed door has improved sealing capability and can be easily shipped and assembled at a job site.

In the preferred and illustrated embodiment, a door assembly is disclosed and includes a door frame formed by prefabricated vertical frame members interconnected with prefabricated lateral frame members. Insulated panel sections are replaceably supported by the door frame. At least one but preferably multiple, replaceable, peripheral door seals are held in track ways defined by the vertical and lateral frame members.

According to a feature of the invention, the lateral and vertical frame members each include a plurality of T-slots for receiving threaded members engagable with threaded fasteners to hold the panel sections to the door frame.

According to another feature of the invention, the door assembly further includes a clamp pressure receiving structure for receiving clamping pressure exerted by a clamp mechanism that forms part of the kiln structure. In the illustrated embodiment, the clamp mechanism is located adjacent a door opening in the kiln structure. The clamping mechanism applies a predetermined clamping pressure to the door assembly in order to provide a sealing engagement between at least a portion of the peripheral door seals and the door opening in the kiln.

According to another feature of the invention, the door assembly includes at least one roller that extends outwardly and is engagable by another, passing door assembly.

Additional features of the invention will become apparent and a fuller understanding obtained by reading the following detailed description made in connection with accompanying drawings.

### BRIEF DESCRIPTION OF DRAWINGS

FIG. 1 is an elevational view of a kiln door constructed in accordance a preferred embodiment of the invention;

FIGS. 1A-1C illustrate the interconnection between vertical and lateral frame members that form part of the kiln door shown in FIG. 1;

FIG. 2 is a fragmentary sectional view of the kiln door as seen from the plane indicated by the line 2-2 in FIG. 1;

FIG. 3 is a fragmentary sectional view of the kiln door as seen from the plane indicated by the line 3-3 in FIG. 1; and

FIG. 4 is another fragmentary sectional view of the kiln door as seen from the plane indicated by the line 4-4 in FIG. 1.

### BEST MODE FOR CARRYING OUT THE INVENTION

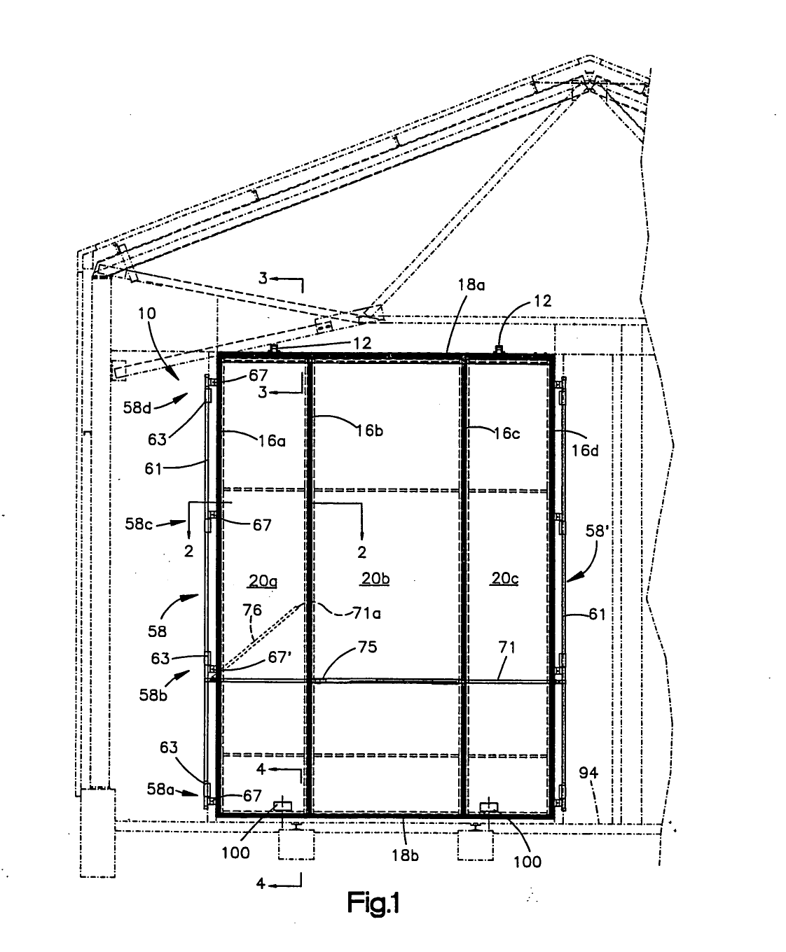

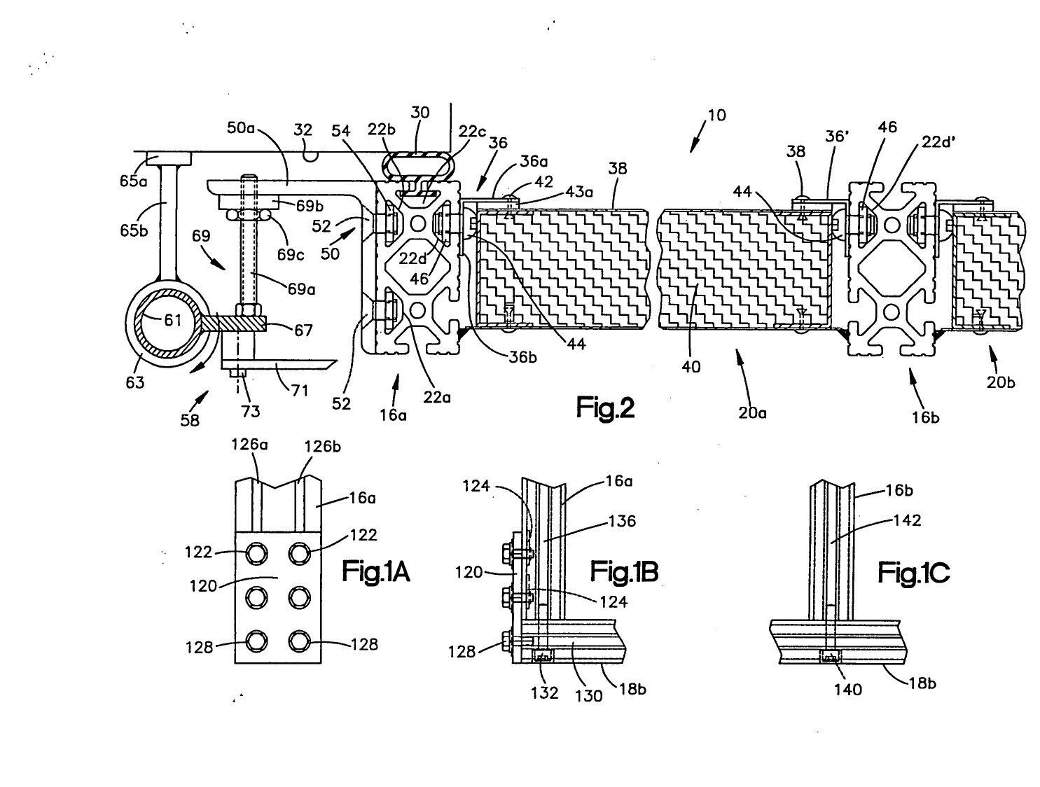

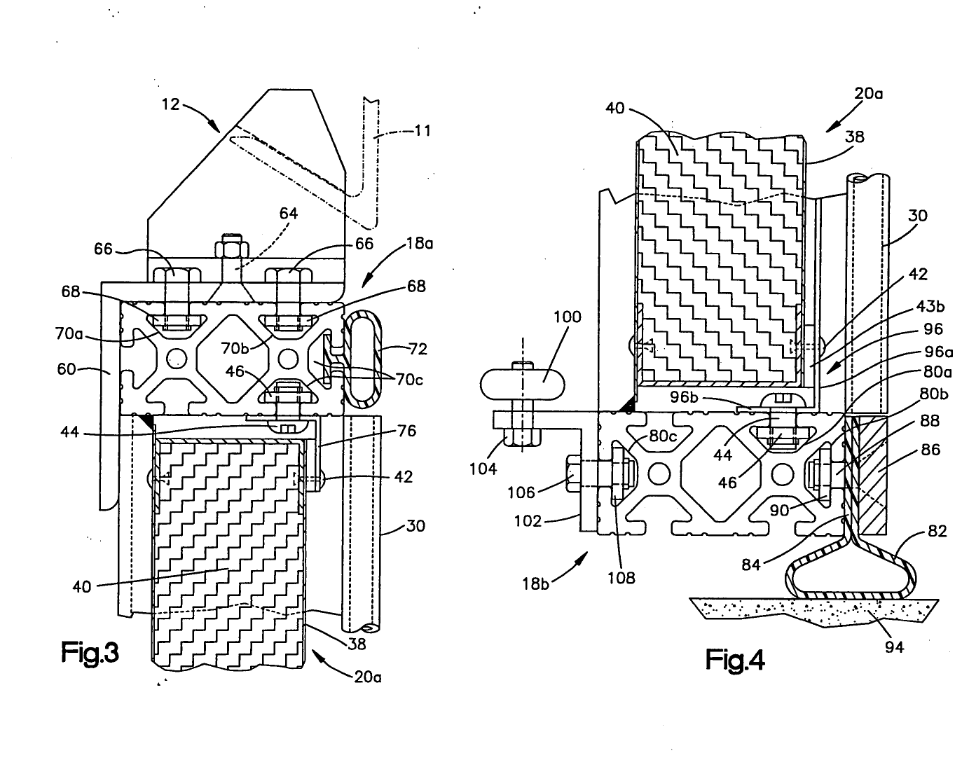

FIG. 1 illustrates the overall construction of a kiln door 10 constructed in accordance with the preferred embodiment of the invention. In the illustrated embodiment, the door 10 is of the type that is hung from hooks 11 (one which is shown in FIG. 3) by a pair of hangers 12. The hooks 11 are attached to the door frame of the Kiln 14. A door carrier (not specifically shown) is used to raise the door 10 off the hooks and support it for lateral movement with respect to the door frame. The construction of the hangers 12 and the method by which they interact with the door carrier is conventional. In operation, a mechanism forming part of the door carrier (not shown) raises the door slightly and due to the engagement between the hangers 12, the hooks 11 and the door carrier, the door 10 moves upwardly and outwardly from the door opening defined by the kiln structure 14, a portion of which is shown in phantom. As is also conventional, once the door 10 is raised and moved outwardly, an operator can slide the door sideways with respect to the door opening in order to provide access to a lumber drying chamber defined by the kiln structure 14. When the door is to be closed, the door 10 is moved laterally into a closed position so that it overlies the door opening. The door is then lowered by the door carrier mechanism. As it is lowered, it moves towards the perimeter of the door opening.

Referring also to FIGS. 2 and 3, the door 10 comprises an assembly and includes a door frame that is defined by vertical frame members 16a, 16b, 16c, 16d and horizontal frame members 18a and 18b. Insulated panel sections 20a 20b, 20c span between the vertical frame members and are fixed to and supported by the door frame. In the preferred illustrated embodiment, both the vertical and horizontal frame members 16a-16d, 18a, 18b comprise extrusions that define a plurality of longitudinal retainer tracks or T-slots. These T-slots enable peripheral components to be easily attached to the frame member.

In particular, the outermost frame members 16a, 16d are rectangular in cross section and include a plurality of T-slots and in particular include T-slots 22a, 22b, 22c, 22d. In the preferred illustrated embodiment, the frame member 16a, 16d are aluminum extrusions. As seen best in FIG. 2, the longitudinal T-slot 22c mounts a replaceable seal 30. When the door 10 is in its closed position, the seal 30 engages a door-jam surface 32. The sealing engagement provided between the door jam 32 and the seal 30 inhibits the escape of gases from inside the kiln structure past the vertical member 16a and/or the entry of air into the kiln chamber. Another longitudinal T-slot 22d located at a position rotated 90 degrees from the T-slot 22c, is used to secure an L-shaped angle or bracket 36 to the vertical member 16a. The L-shaped bracket 36 serves as a mounting point for the insulated panel 20a that extends between the frame member 16a and the adjacent frame member 16b. The panel 20a comprises formed aluminum sheeting 38 that surrounds and contains insulation 40. The panels 20b, 20c are similarly constructed.

In the preferred embodiment, a panel i.e. panel 20a is secured to one leg 36a of the angle bracket 36 by a plurality of rivets 42. A sealing gasket 43a is sandwiched between the panel 20a and the leg 36a. The angled bracket 36 is secured to the frame member by a plurality of threaded fasteners 44 that engage associated nuts 46 held in the T-slot 22d. As seen in FIG. 2, a similar angle bracket 36′ is attached to the frame member 16b using threaded fasteners 44 that engage nuts 46 held in a longitudinal T-slot 22d′ forming part of the frame member 16b.

In the embodiment of the kiln door shown in FIG. 1, a clamping arrangement is used to urge or press the door into sealing, abutting engagement with the door frame. To achieve this feature, four (4) L-shaped brackets 50 are secured to the frame member 16a by a plurality of screws 52 that engage nuts 54 held in the T-slots 22a, 22b. A clamp mechanism indicated generally by the reference character 58 is operated to engage laterally extending legs 50a of the brackets 50 (one is shown in FIG. 2) in order to urge the door 10 towards the door jam 32, thus compressing the vertical door seal 30 as seen in FIG. 2.

Referring to FIGS. 1 and 2, the preferred door clamping arrangement is constructed as follows. In the preferred and illustrated arrangement, the clamping mechanism includes four individual clamp members 58a-58d on the left side of the door opening as viewed in FIG. 1. Referring also to FIG. 2, each clamp member 58a-58d is secured to a common pipe or shaft 61. The shaft 61 is rotatable within aligned holders 63 associated with the clamp members 58a-59d. Each holder 63 is attached a spaced distance from the door jam surface 32 by a mounting foot 65a, and mounting leg 65b. The holders define a vertical axis of rotation for the shaft 61 and hence the clamping members 58a, 58b which are attached to and concurrently rotate with the shaft 61.

Four spaced apart clamping bars 67 are fixed as by welding to the rotatable pipe/rod 61 carried by the holders 63. An adjustable clamp stop 69 is threadedly connected to each bracket leg 50a and in alignment with an associated clamping bar 67. The stops 69 may comprise elongated bolts 69a which are threadedly received by an associated boss 69b that is attached to the angle leg 50a. The threaded connection allows the position of the stop bolt 69a to be adjusted in order to adjust the clamping force applied by the associated clamping bar 67. The position at the stop bolt 69a is secured by a locking nut 69c.

Referring also to FIG. 1, an operating handle 71 is pivotally connected to one of the clamping bars, i.e., the clamping bar indicated by the reference character 67′ in FIG. 1. In the illustrated embodiment, a bolt 73 secures the handle 71 to the clamping bar 67, but allows pivotal movement. The outer or distal end of the operating handle 71a is receivable in a locking clip 75 attached to the door (shown in FIG. 1).

To operate the clamping mechanism, the handle is rotated upwardly about its pivot bolt 73, as seen in FIG. 1 (after the door is moved to its closed position). The operator then pushes the handle 71 towards the door and in so doing rotates the clamping bars 67 counterclockwise as viewed in FIG. 2, thus engaging and subsequently applying clamping pressure to the associated stop bolts 69. The handle 71 is then rotated downwardly (about the pivot bolt 73) so that it is received by the locking clip 75 which maintains the handle in its clamped position. The stop bolts 69 are adjusted in order to apply a uniform clamping force so that the seal 30 is uniformly compressed when the door is in the closed position.

To open the door, the clamp handle 71 is rotated upwardly about its pivot bolt 73 (as viewed in FIG. 1) and out of the locking clip 75. The handle 71 is then moved away from the door in order to rotate the clamping bars 67 about the vertical axis. Preferably, the clamping bars are rotated 180°, thus positioning the handle 180° from the position shown in FIG. 2. When in this position, the handle 71 is closely positioned to the side of the structure which enables the door (after it is moved upwardly and outwardly by the door carrier mechanism) to move past the clamping mechanism.

In the preferred and illustrated embodiment, a substantially similar clamping mechanism 58′ is located on the right side of the door. In the preferred embodiment, the clamping mechanism 58′ uses the same components as the clamping mechanism 58, but is assembled as a mirror image of the clamping mechanism 58 located on the left side of the door.

In the preferred and illustrated embodiment, the lateral frame members 18a, 18b are substantially identical in profile to the vertical frame members 16a-16d. The lateral frame members 18a, 18b also include longitudinal retaining tracks or T-slots which facilitate the attachment of components to the frame member.

Referring to FIG. 3, which illustrates in cross-section the uppermost lateral frame member 18a, it can be seen that the hangers 12 are held to a top surface of the frame member 18a by virtue of an L-shaped angled bracket 60. In particular, each hanger 12 is held to the bracket 60 by a plurality of threaded fasteners 64. The bracket 60 in turn is held to the frame member 18a by a plurality of bolts 66 that threadedly engage associated nuts 68 that are held in a pair of T-slots 70a, 70b. A laterally extending upper door seal 72 which is similar in profile to the vertical door seal 30 is held in an associated T-slot 70c. The lateral door seal 72 functions in substantially the same manner as a vertical door seal 30 and abuts an upper lateral door jam (not shown). When the kiln door 10 is closed and clamped into position, the lateral seal 72 deforms as shown in FIG. 3 in order to provide a sealing engagement with the door jam or other structure defining the door opening in the kiln 12.

The upper lateral frame member 18a also mounts an angle bracket 76 by which an upper edge of the door panel 20 is attached to the upper level frame. The mounting angle 76 is held to the frame member 18a by a plurality of fasteners 44 that threadedly engage associated nuts 46 held by a T-slot 70c.

The bottom, lateral frame member 18b is preferably the same in profile as the upper frame member 18a and also includes a plurality of T-slots. Referring to FIG. 4, an inner T-slot 80b is used to mount a bottom seal 82 to the bottom edge of the kiln door 10. The bottom seal 82 is clamped between an inner surface 84 of the lower frame member 18b and a laterally extending clamping plate 86 by a plurality of threaded fasteners 88 which engage associated nuts 90 held in the laterally extending T-slot 80a.

As indicated above, as the kiln door 10 moved to its closed position, it moves downwardly (i.e. 2.5 inches). In so doing, the bottom seal 82 engages a floor or door threshold surface 94 and may deform to provide a sealing engagement with the floor or threshold. The lowermost edge of the insulating panel 20a is held to the lower frame member 18b by an angled bracket 96, in which one leg 96a of the bracket 96 is riveted (by the rivets 42) to the panel 20a. A sealing gasket 43b is sandwiched between the panel 20a and the leg 96a. Another leg 96b of the bracket 96 is held to the frame member 18b by threaded fasteners 44 which extend through the leg 96b of the angle bracket 96 and engage associated nuts 46 held in T-slot 80b.

FIGS. 1A, 1B, 1C illustrate the preferred interconnections between the vertical and lateral frame members 16a-16d, 18a, 18b. As seen best in FIGS. 1A and 1B, the vertical member 16a is connected to the bottom, lateral frame member 18b using a butt connection. In particular, a coupling plate 120 is secured to the vertical member 16a using threaded fasteners, i.e., bolts 122 that engage associated nuts 124 held in associated T slots 126a, 126b. The lower end of the coupling plate 120 is concurrently secured to an end of the lateral frame member 18b using a pair of fasteners 128 which are threadedly received in associated threaded bores 130 (only one is shown) defined by the lower frame member 18b.

In addition, a pair of vertically oriented threaded fasteners 132 (only one is shown) extend through vertical bores defined near the end of the lateral frame member 18b and threadedly engage threaded bores 136 (only one is shown) defined by the vertical frame members 16a.

The interconnection between the vertical members 16b, 16c is illustrated in FIG. 1C. In particular, the vertical frame member 16b is secured to the lower frame member 18b by a pair of threaded fasteners 140 which extend through bores defined by the lower frame member 18b and threadedly engage aligned threaded bores 142 defined by the vertical member 16b.

In the preferred and illustrated embodiment, the vertical members 16c and 16d are secured to the lower frame member 18b in substantially the same manner as the vertical member 16a and 16b are attached. A coupling plate 120 would also be used to connect the vertical member 16d to the right end of the lower frame member 18b. In the preferred and illustrated embodiment, the upper lateral frame member 18a is interconnected with the upper ends of the vertical members 16a-16d in the same manner as the lower ends of these vertical members are interconnected with the lower frame member 18b.

According to a feature of the invention, at least a pair of rollers 100 is secured to the bottom frame member 18b. Again, elongated retaining tracks or T-slots facilitate the attachment of these rollers 100. As seen in FIG. 4, an angled bracket 102 mounts a roller 100 which is rotatable about a vertical axis defined by a mounting bolt 104. The bracket 102 is held to the outside of the frame member 18b by a plurality of bolts 106 which engage associated nuts 108 held in T-slot 80c. The rollers 100 allow an adjacent door (not shown) being opened to pass the door shown in the Figures. The rollers 100 contact the inside surface of the passing door and keep the doors from colliding.

According to a feature of the invention, the vertical and lateral frame members 16a-16d, 18a, 18b are commercially available components. For example, frame members of the type shown FIGS. 2-4 are available from 80/20 Inc. By utilizing commercially available extrusions or pre-fabricated beams having slots and bores for receiving fasteners, the illustrated kiln door 10 can be easily assembled, installed and/or repaired.

With the present invention, the components that comprise the door assembly can be shipped to a kiln site as a kit. The frame members could be cut to predetermined dimensions prior to shipment so that simple assembly techniques could be used to construct the door at the job site. More importantly, should the door be damaged in use, the damaged components can be easily repaired. For example, since the seals are held in T-slots, they can easily be slid out of position and replaced. If disassembly of the door is required, this is easily facilitated since the major components are held together using fasteners that engage nuts held in the T-slots.

It should be apparent that the present invention provides a new and improved kiln door that can easily replace existing kiln doors. Shipment of the doors is facilitated since they can be assembled at the job site. The sealing engagement provided by the vertical and lateral seals improve the efficiency of the kiln since the escape of heated air from inside the kiln or the entry of ambient air is substantially inhibited. Finally, the modular construction of the door facilitates repair of individual components including the door panels 20a, 20b, 20c should the door be damaged in use.

The present invention has been disclosed as part of the laterally movable type kiln door which is moved using a door carrier or other similar mechanism. It should be noted, however, that the present invention can be adapted to “barn door” type kiln doors which are hingedly connected to a door opening and are swung about a vertical axis in order to move them from a closed to an open position.

Although the invention has been described with a certain degree of particularity, it should be understood that those skilled in the art can make various changes to it without departing from the spirit or scope of the invention as hereinafter claimed.

We claim:

1. A kiln door assembly, comprising:
a) a door frame formed by prefabricated vertical frame members interconnected with prefabricated lateral frame members;
b) insulated panel sections that are replaceably supported by the door frame; and,
c) replaceable, peripheral door seals held in track ways defined by said vertical and lateral frame members.

2. The kiln door assembly of claim 1, wherein said lateral and vertical frame members each include a plurality of T slots for receiving threaded members engageable with threaded fasteners used to hold said panel section to said door frame.

3. The kiln door assembly of claim 2, further comprising clamp pressure receiving structure to be applied by a clamp mechanism forming part of a door frame which applies a predetermined clamping pressure to said door assembly in order to provide a sealing engagement between at least a portion of said perimeter seals and said door frame.

4. The kiln door assembly of claim 1, further comprising at least one roller extending outwardly from said door assembly engageable by another, passing door assembly.
